(19) United States
(12) Patent Application Publication
(10) Pub. No.: US 2015/0192294 A1
(43) Pub. Date: Jul. 9, 2015

(54) Methods and Systems For Dewatering Bottom Ash Using A Remote Submerged Scraper Conveyor

(71) Applicant: Clyde Bergemann Power Group Americas Inc., Atlanta, GA (US)

(72) Inventors: Gary D. Mooney, Phoenixville, PA (US); Ronald G. Grabowski, Gilbertsville, PA (US)

(21) Appl. No.: 14/597,944

(22) Filed: Jan. 15, 2015

Related U.S. Application Data
(63) Continuation-in-part of application No. 12/913,157, filed on Oct. 27, 2010.
(60) Provisional application No. 61/316,159, filed on Mar. 22, 2010.

(51) Int. Cl. F23J 1/02; F16K 3/24; B01D 21/18; C02F 11/12; B01D 21/00

(52) U.S. Cl. CPC F23J 1/02; C02F 11/12; B01D 21/0087; B01D 21/18; F16K 3/24

(57) ABSTRACT

A variable flow device that can be used to dewater an ash slurry is described. The variable flow device includes a pipe section having a plurality of adjustable openings in the sidewall. The variable flow device can be can be attached to a slurry discharge pipe and positioned above the horizontal section of a submerged scraper conveyor (SSC) located remotely from a boiler or furnace where bottom ash is generated. A bottom ash dewatering system is also described which includes an SSC having an overflow trough system. The trough system includes trough sections adjacent each of the sides of the SSC and one or more trough connecting sections. The SSC equipped with the variable flow device and/or trough system can receive a high volume wet ash slurry discharge while minimizing particulates overflowing into the overflow trough system.

### CROSS REFERENCE TO RELATED CASES

This application is a continuation-in-part of U.S. patent application Ser. No. 12/913,157, filed on Oct. 27, 2010, which claims the benefit of Provisional U.S. Application Ser. No. 61/316,159, filed on Mar. 22, 2010. Each of the above-referenced applications is incorporated by reference herein in its entirety.

### BACKGROUND

1. Technical Field

This application relates generally to methods and systems for dewatering bottom ash and, in particular, to such methods and systems which employ a submerged scraper conveyor located remotely from the boiler or furnace where the bottom ash is generated.

2. Background of the Technology

Bottom ash refers to the non-combustible constituents of coal with traces of combustibles that are embedded in clinkers and that stick to the hot side water walls of a coal-burning furnace during its operation. Bottom ash may be used as an aggregate in road construction and concrete. The portion of the ash that escapes up the chimney or stack is, however, referred to as fly ash. The clinkers fall by themselves to the bottom of the furnace and get cooled, typically in a water impounded ash hopper.

The clinker lumps get crushed to small sizes by clinker grinders and fall down into a trough from where a water ejector pumps them out to a sump or ash pond. In another arrangement a continuous link chain scrapes out the clinkers from under water and deposits them in a bunker outside the boiler room wall.

An alternative bottom ash handling system is the dry conveyor which is a unique system for dry extraction, cooling and handling of bottom ash from pulverized coal-fired boilers. It eliminates water usage in the cooling and conveying of bottom ash. This system cools ash using only a small controlled amount of ambient air.

The two most common bottom ash handling systems used for dewatering bottom ash are conventional tall dewatering bins and Submerged Scraper Conveyors (SSC). Both of these distinct systems produce a relatively “dry” and dewatered product that is nominally 15 to 20% water by weight and presently acceptable for over the road transport in open top dump trucks covered by a loose tarpaulin. The main difference between these two systems is that the SSC achieves the 20% water by weight result continuously while the dewatering bins require a 6 to 8 hour decanting time cycle to allow the water retained by the ash to seep out through decanting screens.

Ash dewatering in a conventional tall dewatering bin system can be divided into several basic time periods. Initially, all of the water flowing through a discharge pipeline leading away from the ash hopper under a boiler is conveyed up the sidewall of a tall dewatering bin and deposited into the middle of an underflow baffle at the top of the bin. No “dewatering” occurs at this time but the bottom ash starts to separate from the conveying water and drop to the bottom of the bin. This naturally reduces the water content of the ash to about 50% water by volume since bottom ash is considered to have 50% voids as well as a basic 45-50 pound per cubic foot (721 to 801 kg/cubic meter) bulk density. The conveying water in this phase flows under an underflow baffle and upwards and over to an overflow trough that is installed around the inner perimeter of the bin. This overflow trough can have a flat top edge or a serrated weir or some other form of screening to prevent smaller ash particles from leaving the bin. Nevertheless, the parts per million (ppm) of particles leaving the bin in this stage can exceed 1,000 ppm. After the initial conveying water flow is finished, or at least diverted to another dewatering bin, the dewatering bin no longer overflows. The high water flow stops. At that point decanting valves are opened to allow the upper water level and ash water content to be siphoned off from above the layer of ash as well as from between the interstitial voids in the ash itself. The bin is lined with multiple decanting screens and other decanters to slowly allow water to trickle out of the ash, past the screens in the decanters, and down through drain troughs and drain pipes to a settling pond, tank, basin or sump. If the water flow rate is controlled by the setting on the drain valves (not fully open at all times), the particulate carryover rate can be reduced below 500 ppm during this stage.

Whether a conventional tall dewatering bin or an SSC is used to dewater the ash, the overflow water from either system contains too much particulate to allow it to be returned to the environment without further treatment. Generally a two step process is used. Water overflowing a dewatering bin or SSC flows initially to a holding “area” where the water flow rates are greatly reduced and additional particulate is allowed to “settle.” This accumulated “sludge” of fine particles can be pumped back to the dewatering bin or SSC but should be kept away from any decanting screen areas. After moving through the “settling” area of a pond, tank or sump, the water is clearer and the particulate content has been reduced to ˜100 ppm. It is then allowed to overflow into a storage area to await possible recirculation back to the boiler/ash hopper areas of the plant. If a pond is not used, a “surge” tank is used to hold sufficient water to start up the bottom ash system for each boiler by filling all pipelines and one or more dewatering bins.

The advantage of an SSC over a conventional tall dewatering bin system in the overflow water process is that typically the water flows are much less with an SSC system. In a typical SSC system, the maximum incoming water flow is associated with the mill rejects system(s) where each jet pump at each mill discharges approximately 400 to 1,000 Gallons per Minute (GPM) (91 to 227 cubic meters/hr) to the SSC. Mill rejects need to be conveyed at ˜10 feet per second (11 km/hr) while bottom ash can be conveyed at ˜7.5 feet per second (˜8.2 km/hr). Mill rejects often need only 4″ to 6″ (10 to 15 cm) pipelines to the SSC where bottom ash lines to ponds or dewatering bins may be 8″ to 14″ (20 to 36 cm) in diameter due to the larger ash generation rates and conveying distances.

As a result, only the tall dewatering bin system is capable of handling the high volume bottom ash slurry discharges currently pumped to ash ponds. Conventional SSCs, which are not equipped to handle these high volume discharges, have previously been located under dedicated boilers. There is, therefore, a continuing need for improved bottom ash dewatering systems that can take advantage of the benefits of the SSC as well as the tall dewatering bins for high volume bottom ash slurry discharges including those currently pumped to ash ponds.

### SUMMARY

According to a first embodiment, a variable flow device is provided which comprises:
a pipe section comprising a wall extending along an axis, the pipe section having a first end and a second end;
a first opening in a first side of the wall of the pipe section;
a second opening in the first side of the wall of the pipe section displaced from the first opening along the axis of the pipe section;
a first adjustable sleeve around the pipe section adjacent to or covering at least part of the first opening, the first adjustable sleeve adapted to be displaced axially with respect to the pipe section to allow the amount of the first opening covered by the sleeve to be adjusted; and
a second adjustable sleeve around the pipe section adjacent to or covering at least part of the second opening, the second adjustable sleeve adapted to be displaced axially with respect to the pipe section to allow the amount of the second opening covered by the sleeve to be adjusted.

According to a second embodiment, a bottom ash dewatering system for a boiler is provided which comprises:
a submerged scraper conveyor located remotely from the boiler, the submerged scraper conveyor comprising a horizontal section, a dewatering incline section, and a conveyor running through the horizontal and dewatering incline sections;
an ash hopper located under the boiler; and
a slurry discharge pipe adapted to deliver a wet ash slurry from the ash hopper into the horizontal section of the submerged scraper conveyor, wherein the slurry discharge pipe comprises a variable flow device as set forth in Claim 1 positioned above the horizontal section of the submerged scraper conveyor such that slurry pumped through the slurry discharge pipe flows through the first and second openings and into the horizontal section of the submerged scraper conveyor.

According to a third embodiment, a bottom ash dewatering system for a boiler is provided which comprises:
a submerged scraper conveyor located remotely from the boiler, the submerged scraper conveyor comprising a horizontal section comprising first and second side walls and first and second ends, a dewatering incline section adjacent a first end of the horizontal section, and a conveyor running through the horizontal and dewatering incline sections;
an ash hopper located under the boiler;
a slurry discharge pipe adapted to deliver a wet ash slurry from the ash hopper into the horizontal section of the submerged scraper conveyor; and
an overflow trough system comprising a first trough section adjacent the first side wall of the horizontal section, a second trough section adjacent the second side wall of the horizontal section opposite the first trough section and one or more trough connecting sections between the first trough section and the second trough section;
wherein the horizontal section of the submerged scraper conveyor has a water line defining a level above which water in the horizontal section will overflow into the overflow trough system; and
wherein the conveyor runs through the horizontal section at a level below the water line.

According to a fourth embodiment, a method of conveying bottom ash generated from combustion in a furnace is provided which comprises:
combining the ash with water to form a slurry;
pumping the slurry to a submerged scraper conveyor located remotely from the furnace, the submerged scraper conveyor comprising:
a horizontal section;
a dewatering incline section;
a conveyor running through the horizontal and dewatering incline sections;
an overflow trough system; and
a weir system located between the horizontal section of the submerged scraper conveyor and the overflow trough system;
   wherein the horizontal section contains water and has a water line defining a level above which water in the horizontal section will flow through the weir and into the overflow trough, wherein the conveyor runs through the horizontal section at a level below the water line and wherein the slurry is pumped into the horizontal section of the submerged scraper conveyor; and
conveying the slurry from the horizontal section up the incline section to dewater the slurry;
wherein the slurry is pumped from the furnace to the submerged scraper conveyor at a rate of 1,000 to 10,000 gallons per minute (227 to 2,271 m³/hour); and
wherein the submerged scraper conveyor comprises at least 1 linear foot of weir for each 30 gallons per minute of slurry flow rate;

### BRIEF DESCRIPTION OF THE DRAWINGS

FIG. 1 is a conceptual illustration of a remote submerged scraper conveyor (Remote SSC) according to the present invention.

FIG. 2 is a conceptual illustration of the Remote SSC with a dewatered ash distribution system including a pair of mini-dewatering bins and a reciprocating conveyor.

FIG. 3A is a side cut away view of a Remote SSC with an open top underflow baffle.

FIG. 3B is a top view of the Remote SSC with the open top underflow baffle.

FIG. 3C is a cross-sectional end view of the Remote SSC with the open top underflow baffle.

FIG. 4A is a side cut away view of a Remote SSC with an closed top underflow baffle.

FIG. 4B is a top view of the Remote SSC with the closed top underflow baffle.

FIG. 4C is a cross-sectional end view of the Remote SSC with the closed top underflow baffle.

FIG. 5A is a conceptual cross-sectional end view of a flat weir for the overflow trough of the Remote SSC.

FIG. 5B is a conceptual cross-sectional end view of a serrated weir for the overflow trough of the Remote SSC.

FIG. 5C is a conceptual cross-sectional end view of a mesh screen weir for the overflow trough of the Remote SSC.

FIG. 5D is a conceptual cross-sectional end view of a parallel plate weir for the overflow trough of the Remote SSC.

FIG. 6 is a schematic diagram of a prior art bottom ash disposal system including an ash pond to be decommissioned.

FIG. 7 is a schematic diagram of a Remote SSC bottom ash disposal system with one Remote SSC provided for a respective boiler.

FIG. 8 is a schematic diagram of a Remote SSC bottom ash disposal system in which one Remote SSC is provided for multiple boilers.

FIG. 9 is a schematic diagram of a Remote SSC bottom ash disposal system with a wet ash hydraulic distribution system.

FIG. 10 is a schematic diagram of a Remote SSC bottom ash disposal system with a dewatered ash distribution system including a pair of mini-dewatering bins and a reciprocating conveyor.

FIG. 11 is a schematic diagram of a Remote SSC bottom ash disposal system with a wet ash hydraulic distribution system and a dewatered ash distribution system.

FIG. 12 is a schematic diagram of a variable flow device which can be used in a bottom ash dewatering system.

FIG. 13 is a schematic diagram of a variable flow device positioned above the horizontal section of a submerged scraper conveyor.

FIG. 14A is a schematic diagram of a trough system for a submerged scraper conveyor.

FIG. 14B shows the trough system of FIG. 14A positioned adjacent the end of the horizontal section of the submerged scraper conveyor opposite the incline section.

FIG. 15A is a simulation showing water flow direction and velocity in a lateral cross section of a submerged scraper conveyor at a position just below the waterline wherein slurry is delivered using a variable flow device.

FIG. 15B shows the position of the lateral cross-section of FIG. 15A in relation to the submerged scraper conveyor.

FIG. 16A shows the water flow direction and velocity in a lateral cross section of a submerged scraper conveyor at a position below the inlet/underflow baffle.

FIG. 16B shows the position of the lateral cross-section of FIG. 16A in relation to the submerged scraper conveyor.

FIG. 17A shows the water flow direction and velocity in a transverse cross section of a submerged scraper conveyor at a position bisecting the inlet/underflow baffle.

FIG. 17B shows the position of the transverse cross-section of FIG. 17A in relation to the submerged scraper conveyor.

FIG. 18A shows the water flow direction and velocity in a transverse cross section of a submerged scraper conveyor at a position between the inlet/underflow baffle and the trough system.

FIG. 18B shows the position of the transverse cross-section of FIG. 18A in relation to the submerged scraper conveyor.

FIG. 19A shows the water flow direction and velocity in a transverse cross section of a submerged scraper conveyor at a position in the settling zone.

FIG. 19B shows the position of the transverse cross-section of FIG. 19A in relation to the submerged scraper conveyor.

FIG. 20 is a chart showing slurry flow rate through a pipeline as a function of inside pipe diameter and line velocity.

### DETAILED DESCRIPTION

The present invention may be embodied in a bottom ash dewatering system for a boiler that includes a submerged scraper conveyor located remotely from the boiler at or above grade level (Remote SSC). The submerged scraper conveyor includes a horizontal section, a dewatering incline section, a conveyor running through the horizontal and dewatering incline sections, and a slurry processing system. A slurry processing system, which is integrated with the horizontal section of the submerged scraper conveyor, receives a bottom ash slurry discharge from a remotely located ash hopper under the boiler. The slurry processing system includes an overflow trough system with a first overflow trough located exterior to and alongside an upper edge of a first side of the horizontal section of the submerged scraper conveyor and a second overflow trough located exterior to and alongside an upper edge of a second side of the horizontal section of the submerged scraper conveyor. It also includes a weir system with a first weir located in a first water flow direction between the horizontal section of the submerged scraper conveyor and the first overflow trough and a second weir located in a second water flow direction between the horizontal section of the submerged scraper conveyor and the second overflow trough.

The slurry processing system may also include an underflow baffle system located within the horizontal section of the submerged scraper conveyor for directing the slurry downwards toward the conveyor to allow ash to settle out of the slurry by gravity while forcing water to follow a tortuous path downward and then upward around the underflow baffle system. The underflow baffle system may have an open or closed top box structure located partially above the horizontal section of submerged scraper conveyor that extends downward to a position below a water line in the horizontal section of the submerged scraper conveyor.

As an alternative, the bottom ash dewatering may further include a wet ash hydraulic distribution system for selectively delivering bottom ash slurry discharges to the slurry processing system from multiple boilers and an ash removal control system for remotely controlling the wet ash hydraulic distribution system. Another alternative includes a dewatered ash distribution system for selectively conveying dewatered ash discharged from the submerged scraper conveyor to a plurality further dewatering locations, which may also be remotely controlled by the ash removal control system. The further dewatering locations typically include one or more dewatering bins.

The bottom ash slurry discharge typically exhibits a flow of at least 1,000 gallons-per-minute (227 cubic meters/hr) while the submerged scraper conveyor is configured to discharge dewatered ash having water content not greater than 20% water by weight. When additional dewatering bins are used, they further dry the ash to not greater than 15% water by weight.

It will be further illustrated how the present invention avoids the drawbacks of prior bottom ash dewatering systems and provides an improved Remote SSC with a number of significant advantages. The specific techniques and structures for creating the Remote SSC, and thereby accomplishing the advantages described above, will become apparent from the following detailed description of the embodiments and the appended drawings and claims.

The present invention may be embodied in a Remote Submerged Scraper Conveyor (Remote SSC) bottom ash dewatering system, which represents a new technique for dewatering bottom ash from a coal-fired boiler developed by repositioning known and proven equipment in new locations to offer a unique cost savings design. The Remote SSC is located at some distance from the boiler instead of being positioned directly under the boiler like a conventional SSC. The Remote SSC also includes a slurry processing system integrated with the horizontal section of the SSC allowing it to handle the high volume of wet bottom ash slurry conventionally pumped into ash ponds or tall dewatering bins. Existing (or new) hydraulic sluice pipelines convey the bottom ash slurry from the boiler area ash hopper to the Remote SSC, instead of to the ash ponds or tall dewatering bins. As a result, much higher amounts of water and slurry enter the Remote SSC than enter a conventional SSC located under a boiler. The slurry processing system integrated with the horizontal section accommodates this increased level of water overflow in the Remote SSC using designs similar to proven techniques in the upper levels of conventional tall dewatering bins.

In the Remote SSC dewatering system, the SSC's function is mainly to dewater the bottom ash, as traditional SSCs have been doing successfully in the United States for over thirty (30) years. However, the Remote SSC includes a new slurry processing system integrated with the horizontal section of the SSC that provides a water overflow design and equipment that is larger than “normal” to handle the incoming sluice water of a traditional pond disposal system or tall dewatering bin system. Similar design techniques of conventional tall dewatering bins are used in different and separate locations to address the water underflow, overflow and particulate carryover rates at the Remote SSC. With the inlet to the Remote SSC close to grade level, power savings are achieved by not having to pump the slurry up the top of the tall dewatering bins. The Remote SSC then dewaters the bottom ash, as in a conventional SSC, by carrying it up the incline while the overflow water is directed to drain or further clarification or recirculation. The Remote SSC therefore provides the advantages of the SSC as well as those of conventional tall dewatering bins for high volume bottom ash slurry discharges including those currently pumped to ash ponds. This makes the Remote SSC a highly advantageous replacement option for current ash pond disposal systems that need to be decommissioned.

The Remote SSC therefore provides a modern bottom ash dewatering system for plants that currently pump their bottom ash to ponds and cannot, for a variety of reasons, retrofit mechanical conveyors for continuous removal directly underneath the boiler. These reasons include, but are not limited, to: (1) Ash hoppers that are in pits and surrounded by too much boiler steel and too many pulverizers to allow the installation of just one Submerged Scraper Conveyor, SSC, or Dry Conveyor; (2) The Boiler is a Base Loaded Unit and the amount of Outage Time needed to demolish the existing ash hopper equipment and install a new system (estimated at 6-8 weeks minimum) either is not available or would be too costly in terms of lost revenue; and (3) In plants with multiple Units, the cost of one (or two) common Submerged Scraper Conveyor(s) located away from the Boiler Islands would be less expensive than installing an SSC or Dry Conveyor under each Boiler.

The Remote SSC dewatering system combines the benefits of a conventional SSC with the benefits of a conventional tall dewatering bin system to produce a final bottom ash product that is below 20% water by weight and provides water for reuse with a low particulate level in parts per million (ppm). This combination requires much less power to operate than a totally conventional water recirculation system and provides better control over the final products.

The Remote SSC dewatering system is typically located between the boiler(s) and the ash pond. The SSC typically operates continuously to remove the incoming bottom ash at the bottom ash generation rate. The ash enters the horizontal section of the SSC and is immediately and continuously conveyed up an incline that dewaters the ash to approximately 15-20% water by weight. In other words, the SSC performs a similar function for ash removal that it does when located directly under the boiler, without having to contend with large ash/slag falls from a tall boiler. Since the incoming “batch” rate of the bottom ash system can be as much as two to eight times the ash generation rate, the SSC stores approximately 4 to 8 Hours worth of ash generation—much like they do when positioned directly under the boiler.

Each Remote SSC has a variable speed drive that can increase the chain speed at any time to remove a surge of incoming ash—such as during sootblowing cycles—but slower speeds provide better dewatering. The set speed should set the ash removal rate at the ash generation rate. In the Remote SSC dewatering system, the SSC handles the initial, upper water overflow rate traditionally handled by a tall, circular dewatering bin. The Remote SSC provides the same, or more, linear feet of overflow trough length in a set of straight overflow troughs on one or both sides of the SSC that a traditional dewatering bin has in its upper, circular overflow trough. The initial water overflow rate can therefore be the same for the Remote SSC dewatering system as for a traditional dewatering bin. Various existing techniques can be used to control the water overflowing the SSC to limit particulate carryover.

In a traditional arrangement, two (2) dewatering bins are sized for seventy-two (72) hour storage (total) with truck or railcar removal clearance directly underneath. These dewatering bins can often be 25 to 35 feet (7.6 to 10.7 meter) in diameter or more and require the incoming pipelines to be raised well over fifty feet (15.2 meter) from grade. This “lift” converts directly into an increased total dynamic head (TDH) requirement on the existing high pressure water supply pumps already supplying high pressure water to any existing jet pumps. Even when centrifugal slurry pumps are being used to pump bottom ash to the ponds, they would have to be resized and retrofitted with larger motors to pump the ash to the top of the dewatering bins.

By using a Remote SSC positioned at or slightly above grade and closer than the current pond (design) discharge point, there will no increase, and a possible decrease, in water supply pump TDH, thus eliminating any need for larger motors and any changes to the motor control center (MCC). As a result, the Remote SSC at or slightly above grade performs the same function as the upper overflow trough in a dewatering bin but at a much lower height above grade, thus saving a major amount of horsepower on the water supply pumps.

The Remote SSC dewatering system may also include an optional hydraulic slurry handling system and/or an optional dewatered ash handling system. The hydraulic slurry handling system allows a single Remote SSC to handle the slurry discharges from multiple boilers. The dewatered ash handling system provides for additional dewatering of the ash after the Remote SSC. Following the bottom ash up the SSC incline, normally 12 to 20 feet (3.7 to 6.1 meter) of dry running length of incline above the water level is needed to reach the 20% water by weight level. In most cases, the Remote SSC provides more than 20 feet (6.1 meter) of dry incline length to provide even better dewatering and allow the headroom required to provide the rest of the optional dewatering equipment. Keeping in mind that traditional dewatering bins need 6-8 hours from the end of the incoming batch conveying phase to reach 20% water by weight, using 4-6 hours of stationary (ash) decanting time to take ash that is already less than 20% water by weight reduces its moisture content even further. Two (2) mini-dewatering bins may provide the secondary decanting after the Remote SSC. These have lower decanting screens and water collecting header rings. To distribute the bottom ash from the top of the SSC into either bin the system includes a reversing horizontal belt conveyor.

After each mini-dewatering bin has allowed the water in the full bin to seep out and lower the moisture content of the ash in the bin, the bottom gate opens and deposits the bin contents onto a single belt conveyor located just above grade. This belt conveyor typically runs underneath both mini-dewatering bins and conveys the ash over to the common ash disposal “stockout” area with several days (at least 3 days) storage time. Trucks can be loaded from this stockpile. The mini-dewatering bins will perform the same lower, stationary decanting function as traditional dewatering bins and allow entrained water to seep out of the bottom ash. The ash particulate carryover through the decanting screens should be less due to the absence of the large head of incoming conveying water.

Depending upon the residence time of the ash in the “stockout” area, additional entrained water will seep out and lower the moisture level of the ash even further. A containment trench and water collecting sump with sump pump can be provided to return this water to the SSCs. Consideration should also be given to enclosing the “stockout” area to prevent rainfall from adding water back to the dewatered ash.

The dewatering system may also include an optional water overflow system. Returning to the SSC overflow troughs, there will be thousands of gallons of water per minute (GPM) (hundreds of cubic meters/hour) overflowing the SSC while the “batch” conveying system is in operation (minus a few GPM carried over with the bottom ash up the SSC incline). Again referring back to conventional tall dewatering bin system design logic, a conical bottom circular “settling tank” with underflow baffle and overflow trough can be used or an inground sump. According to typical design techniques (e.g. EPRI Report CS-4880 January 1987), most systems should have a minimum 50 foot (15.2 meter) diameter settling tank with a 45 degree conical bottom and a 4 foot (1.2 meter) cylindrical section. This can be converted to a “required” value for cubic feet of water storage.

If an above settling grade tank is used, it would typically be about 30-40 feet (9.1 to 12.2 meter) tall above grade. Slurry pumps with smaller impeller clearances would be required to lift the SSC overflow water from about 6 feet (2.0 meter) above grade up to the top of the settling tank and over to the middle of the tank. Additional pumps would also be needed for the water draining from the mini-dewatering bins. Alternatively, the Remote SSC can be positioned on a structured steel platform or a higher ground location to drain by gravity to the above ground settling tank.

If a below ground settling sump is used, the SSC and mini-dewatering bins can all drain by gravity into the sump. Any dirty water from the stockout area can also be pumped more easily to this inground sump as well. Assuming a rectangular ground level sump is used, a dividing wall should be used to allow clearer water to overflow into a second “surge” area. Meanwhile, fines that continually settle out in the sump should be constantly pumped back to the base of the incline of the SSC to begin the dewatering process again. This time they will end up in the very middle of the mini-dewatering bins and be more likely to be carried out to the “stockout” pile.

For example, the system could use either a below grade settling area sump with associated lower horsepower pumps or an above grade settling tank with associated higher horsepower pumps. In either case, the resultant “clear” water needs to be stored in sufficient volume in a “surge” tank or pond prior to recirculation back to the boiler island. Optional additional water equipment would allow the water to be released to the environment.

The Remote SSC dewatering system has a number of advantages over traditional dewatering systems. The Remote SSC dewatering system using a grade level SSC in most cases will not require any additional horsepower back at the boiler unit to increase the total dynamic head (TDH) rating on any existing water supply pump or jet pump. There will typically be enough water pressure in the grade level conveying pipelines to convey the ash slurry a few feet of horizontal length and up a small riser to enter the SSC at approximately ten feet (3.0 meter) above local grade. If the SSC is significantly closer than the design pipeline discharge point at the existing ash pond, there may even be a decrease in TDH requirement for the existing pumps.

The system can also use a traditional “settling” tank/sump concept to further filter the SSC overflow water to required industry levels. By controlling the incoming pipeline conveying rates, the number of slurry jet pumps in operation along with decanting bin valve settings, the level of ppm carryover can be lowered even further. The Remote SSC dewatering system immediately and continuously dewaters the bottom ash to less than 20% water by weight using state of the art SSC technology. In many locations, this is already “dry enough” for immediate truck disposal. The Remote SSC dewatering system uses all of the proven technology of dewatering bins to reduce the particulate carryover in the overflow water. The Remote SSC advantageously separates the two parts of the traditional dewatering bin into the “upper overflow trough” now located on the SSC and the “lower stationary decanting screens” now located as part of mini-dewatering bins. Since the ash leaving the Remote SSC is already “commercially dry” (˜20% moisture content ash) the decanting cycle in the mini-dewatering bins can be shorter and much less susceptible to screen plugging due to the elimination of the high hydrostatic heads of water in traditional dewatering bins.

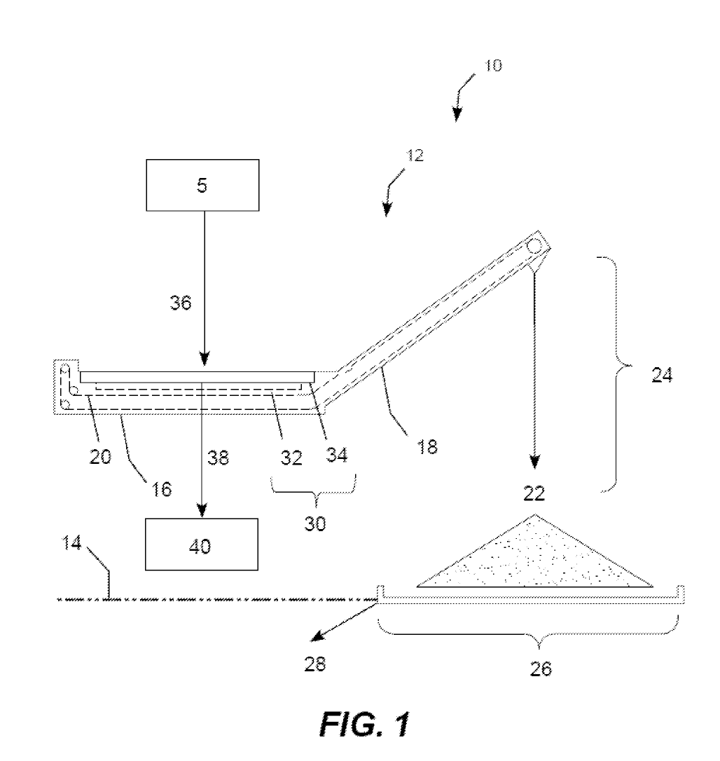

Turning now to the figures, FIG. 1 is a conceptual illustration of a remote submerged scraper conveyor (Remote SSC) 10 according to the present invention. The Remote SSC 10 is based on a conventional SSC 12 that includes a horizontal section 16 and a dewatering incline section 18 with a conveyor 20 that runs through both sections. The conveyor includes flight bars that lift the wet ash separated from the incoming slurry up the dewatering incline section, which dewaters the bottom ash as it rises up the incline. The dewatered ash 22 is dumped from the top of the dewatering incline into a dewatered ash handling system 24, which may include, for example, a discharge chute or secondary conveyor for more distant disposal. In most cases, the dewatered ash is deposited directly or indirectly into an ash pile 26, where a drain 28 removes any additional fluid that seeps from the dewatered ash.

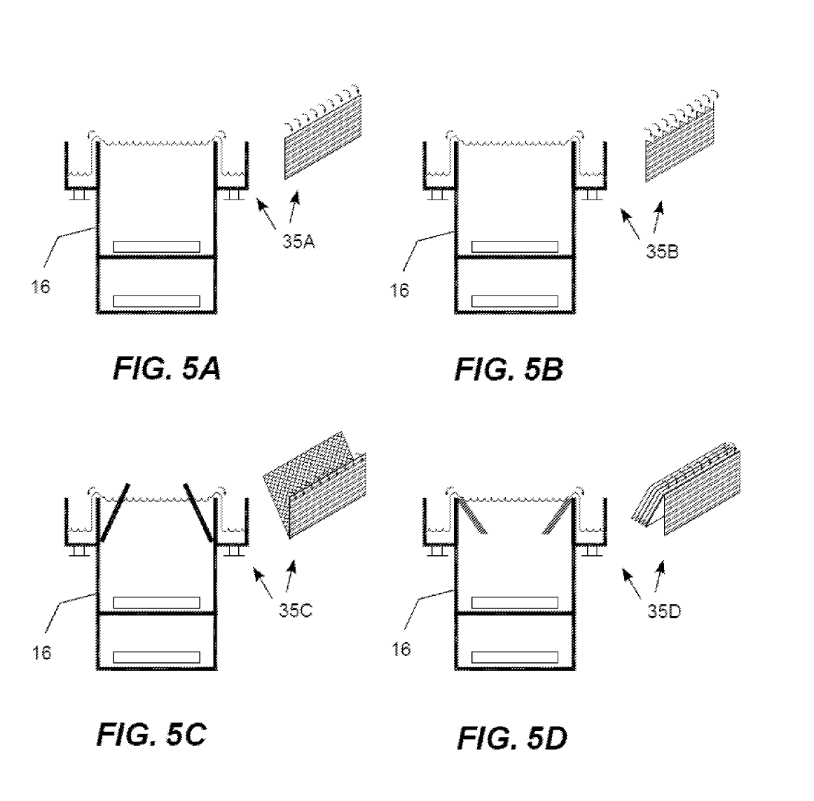

The Remote SSC 10 consists of the conventional SSC 12 described above as modified to include a slurry processing system 30, which allows it to be located remotely from an associated boiler 5 at or slightly above grade level 14 rather than directly under a boiler like a conventional SSC. The slurry processing system 30 includes a pair of overflow troughs 34 and associated weirs (see FIGS. 5A-D) located exterior to and along the top edge of each side of the horizontal section of the SSC. The slurry processing system 30 also typically includes an additional underflow baffle 32, which extends from a position above the water line down into the horizontal section of the SSC below the water line. The slurry processing system 30 allows the Remote SSC 10 to receive a high volume wet ash slurry discharge (e.g. 1,000 to 10,000 GPM) (227 to 2,271 cubic meters/hour) via a slurry discharge pipe 36 conventionally sent to an ash pond or a tall dewatering bin system. A drainage pipe 38 delivers the overflow water collected by the overflow troughs 34 to an overflow water processing system 40 while the bottom ash 22 separated from the overflow water is captured and dewatered by rising up the dewatering incline of the SSC.

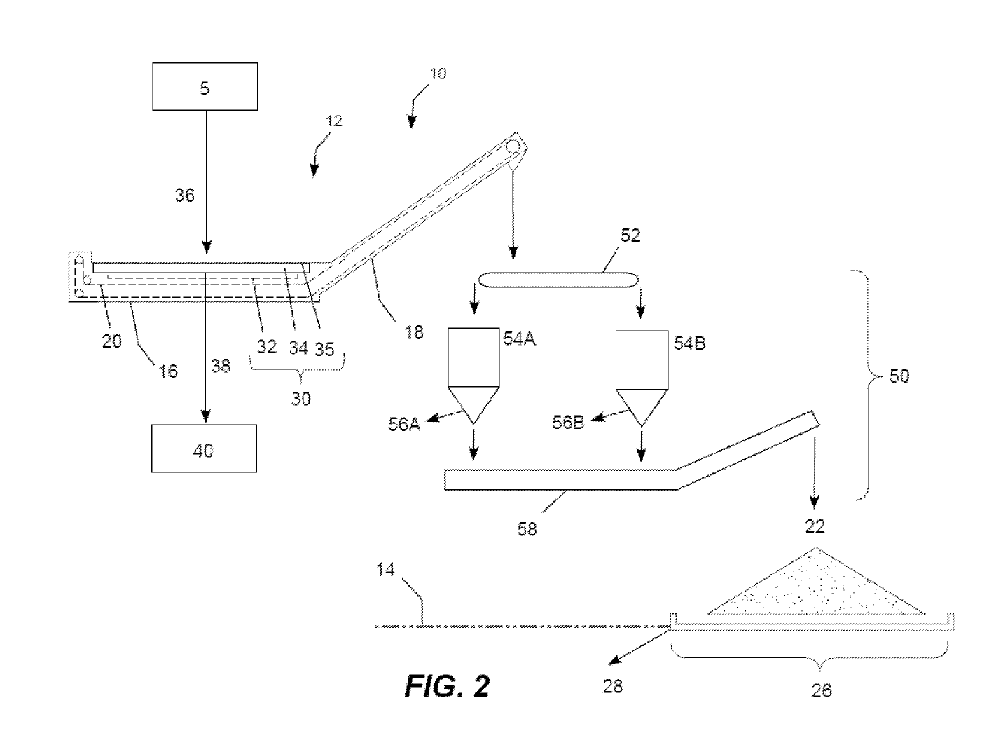

FIG. 2 shows the Remote SSC augmented by a dewatered ash distribution system 50 that includes a pair of mini-dewatering bins 54A-B and a reciprocating conveyor 52 that selectively delivers the dewatered ash 22 to the bins. A secondary conveyor 58 under the mini-dewatering bins 54A-B delivers the dewatered ash from the bins to the ash pile 26. Drains 56A-B remove additional water decanted from the ash in the bins to the overflow water processing system 40. It should be noted that the slurry processing system 30 and the mini-dewatering bins 54A-B provide similar equipment to a conventional tall dewatering bin system except that the overflow troughs and underflow baffle are now located in the slurry processing system 30 integrated with the Remote SSC 10 and the decanting screens are now located in the mini-dewatering bins 54A-B. This configuration has the very significant advantage of providing the same dewatering capacity as the conventional tall dewatering bin system without having to lift the wet ash to the top of the tall dewatering bin. In particular, an existing pump designed to deliver the wet ash slurry to an ash pond will typically be sufficient to pump the wet ash slurry to the Remote SSC 10, whereas new larger capacity pumps would be required to the pump the wet ash slurry to the top of a conventional tall dewatering bin. As a result, the Remote SSC solution saves both the acquisition cost and energy cost needed to operate the new pumps that would otherwise be required to install a conventional tall dewatering bin.

The overflow water processing system 40 may include any of a range of options suitable for a particular application. Typical overflow water options include recirculation of the water back to the boiler, drain to a pond or settling basin, drain to an overflow tank and pump to a pond or basin, drain to a clarifier, or drain to a settling tank then to a surge tank and back to the boiler. The mini-dewatering bins 54A-B provide for additional ash dewatering to augment the dewatering provided by the Remote SSC 10. For example, the water content of the dewatered ash coming from the Remote SSC 10 is typically in the range of 15-20% while the dewatered ash coming from the mini-dewatering bins 54A-B is typically in the range of 10-15%. The specific dewatered ash distribution system 50 shown in FIG. 2 is merely illustrative, and additional bins, conveyors, ash piles and other dewatered ash handling equipment could be utilized as desired.

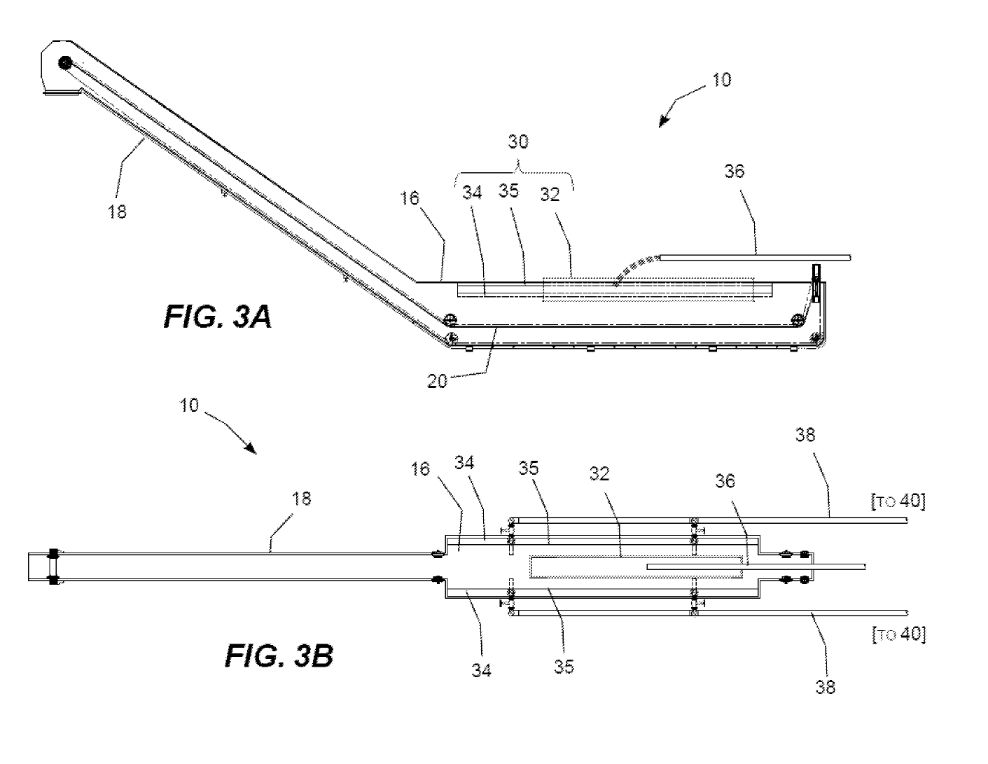

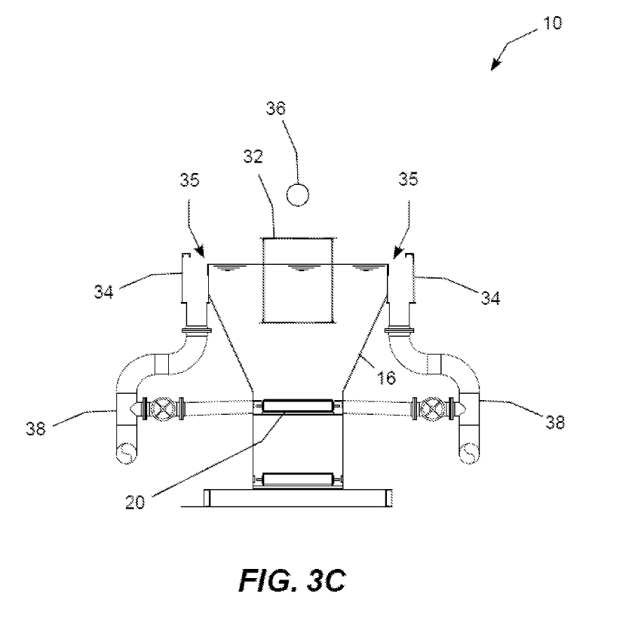

FIG. 3A is a cut away side view, FIG. 3B is a top view, and FIG. 3C is a cross-sectional end view of a first alterative Remote SSC 10 with an open top underflow baffle shown substantially to scale. This configuration includes an underflow baffle 32 with an open top. The slurry discharge pipe 36 delivers the wet slurry to the underflow baffle and the drain pipes 38 carry the overflow water away from the overflow troughs 34 to the overflow water processing system 40. The slurry processing system 30 includes two overflow troughs 34 each positioned exterior to and alongside a top edge of the horizontal section 16 of the SSC. Together, the overflow troughs are designed to handle the overflow volume of the wet ash slurry from the discharge pipe(s) 36, similar to a conventional tall dewatering bin only integrated with the SSC rather than being located at the top of the tall bin. A weir 35 is located in the water flow direction between the horizontal section of the submerged scraper conveyor and each overflow trough. The weir screens large ash particles from entering the overflow trough 34. FIGS. 5A-D show several typical weir designs.

The underflow baffle 32, which is located above the conveyor 20 in the horizontal section 16 of the submerged scraper conveyor, includes an elongated box having an open top and an open bottom located partially above the horizontal section of the Remote SSC and extending downward to a position below the water line in the horizontal section of SSC. This allows ash to settle out of the slurry by gravity while forcing water to follow a tortuous path downward and then upward around the underflow baffle 32, over the weirs 35, into the overflow troughs 34, into the drain pipes 38, and on to the overflow water processing system 40. The bottom ash settles out of the discharge water on the flight bars of the conveyor 20. The Remote SSC then dries the bottom ash as it lifts the ash up the dewatering incline 18. The bottom ash is then unloaded from the Remote SSC to the dewatered ash handling system to an ash pile directly or through a dewatered ash handling system.

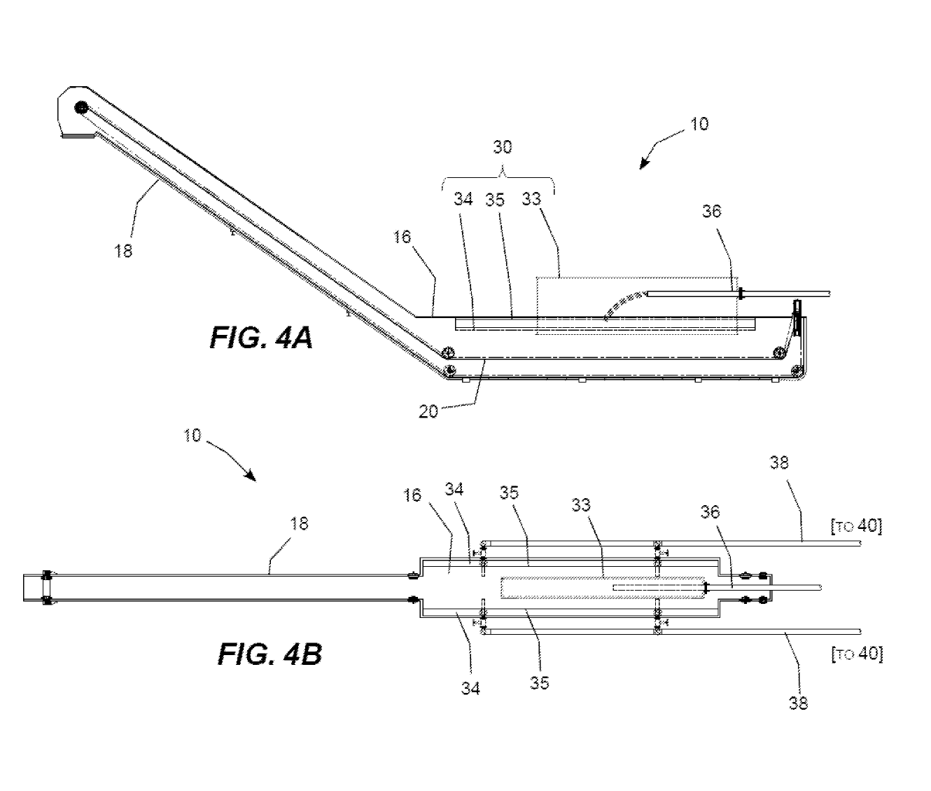

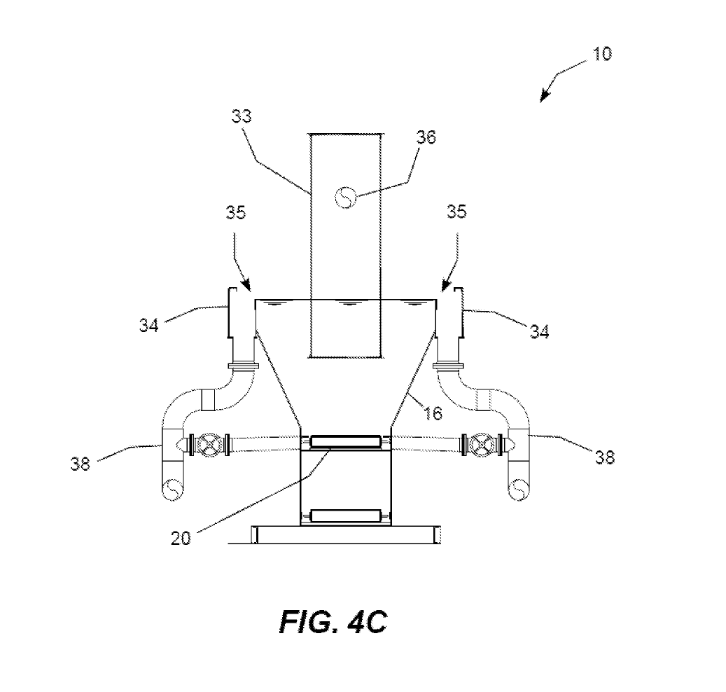

FIG. 4A is a cut away side view, FIG. 4B is a top view, and FIG. 4C is a cross-sectional end view of an alterative Remote SSC 11 with a closed top underflow baffle 33 shown substantially to scale. This type of underflow baffle is known as a target box configuration. The slurry discharge may be directed into target impact plates located inside the target box. Otherwise, the Remote SSC 11 is the same as the Remote SSC 10 described with reference to FIGS. 3A-C. The underflow baffles 32 and 33 are typical and other types of baffles may be selected as a matter of design choice.

FIGS. 5A-D show conceptual cross-sectional end views typical weirs that may be used on the Remote SSC to screen the overflow water as it flows from the horizontal section 16 of the SSC into the overflow trough 34. FIG. 5A illustrates a flat weir 35A, FIG. 5B illustrates a serrated weir 35B, FIG. 5C illustrates a flat weir 35C with an inclined mesh screen, and FIG. 5D illustrates a weir 35D with inclined parallel plates. These weirs are typical and other types of weirs may be selected as a matter of design choice.

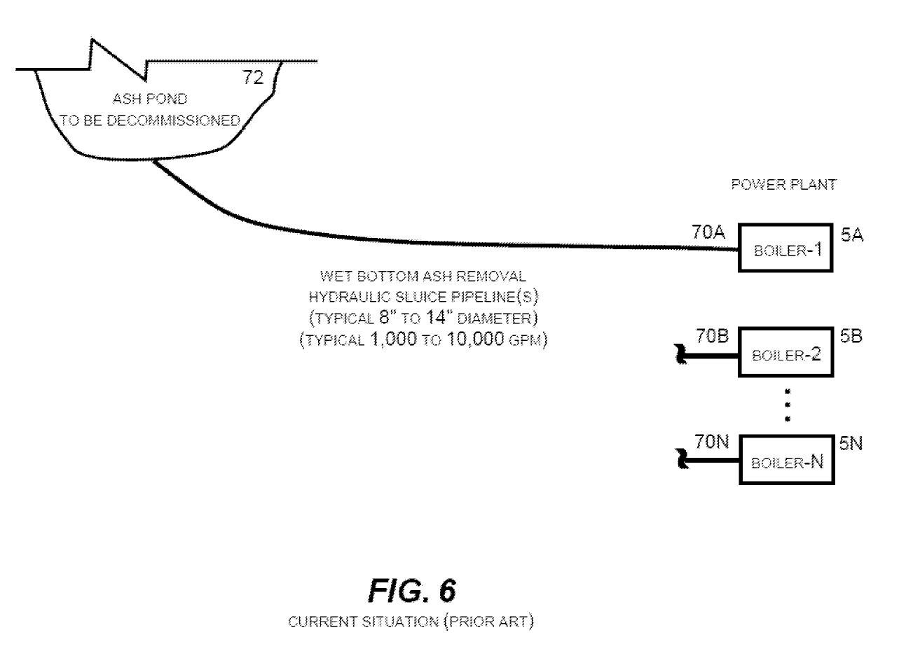

FIG. 6 is a schematic diagram of a prior art bottom ash disposal system including an ash pond to be decommissioned. The power plant includes a number of boilers 5A-N that each deliver wet bottom ash slurry to an ash pond 72 by way of a respective discharge pipe 70A-N. These hydraulic sluice pipelines are typically 8 to 14 inches 8″ to 14″ (20 to 36 cm) in diameter and carry 1,000 to 10,000 GPM (227 to 2,271 cubic meters/hour) of wet bottom ash slurry. The Remote SSC is well adapted to replace the ash pond storage system as many plants are now requiring.

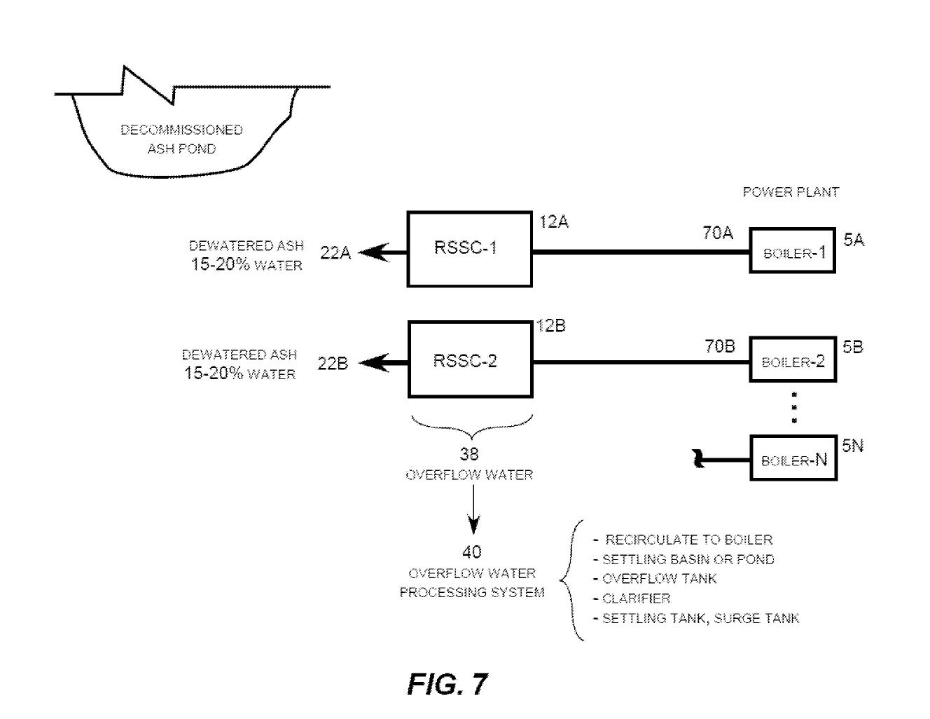

FIG. 7 is a schematic diagram of a Remote SSC bottom ash disposal system with one Remote SSC provided for a respective boiler. That is, the Remote SSC 12A is dedicated to the boiler 5A and the Remote SSC 12B is dedicated to the boiler 5B. The overflow pipes 38 typically drain into a common overflow water handling system 40. The same equipage occurs with conventional SSCs with one SSC located directly under a respective boiler.

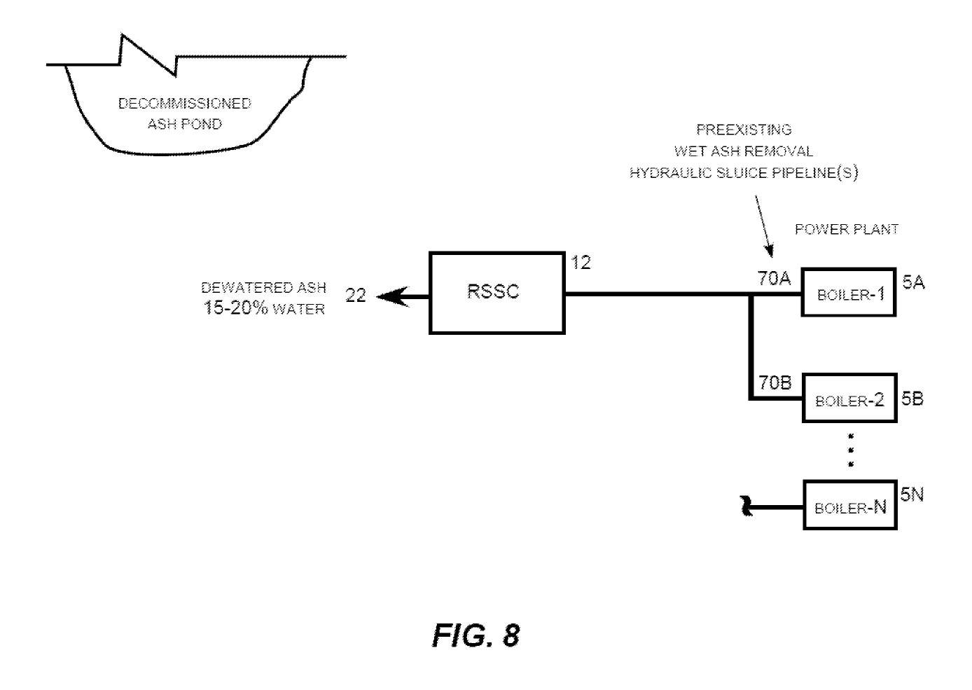

As the Remote SSC is located some distance from the boilers, rather than directly under a respective boiler like a conventional SSC, the Remote SSC affords additional design flexibility in which a single Remote SSC may handle the bottom ash discharge from multiple boilers. FIG. 8 is a schematic diagram of a Remote SSC bottom ash disposal system in which one Remote SSC is provided for multiple boilers. That is, a single Remote SSC 12 handles the bottom ash discharges for two boilers 5A and 5B, which can be extended to additional boilers as a matter of design choice. As high volume bottom ash discharges coincide with occasional boiler cleaning (sootblowing) operations, boiler cleaning can be scheduled among the boilers so that a single Remote SSC sized to handle the maximum discharge from a single boiler can handle multiple boilers conducting sootblowing operations at different times. This is a major advantage of the Remote SSC configuration that is not available with the conventional SSC approach in which an SSC is dedicated to and located directly under a respective boiler.

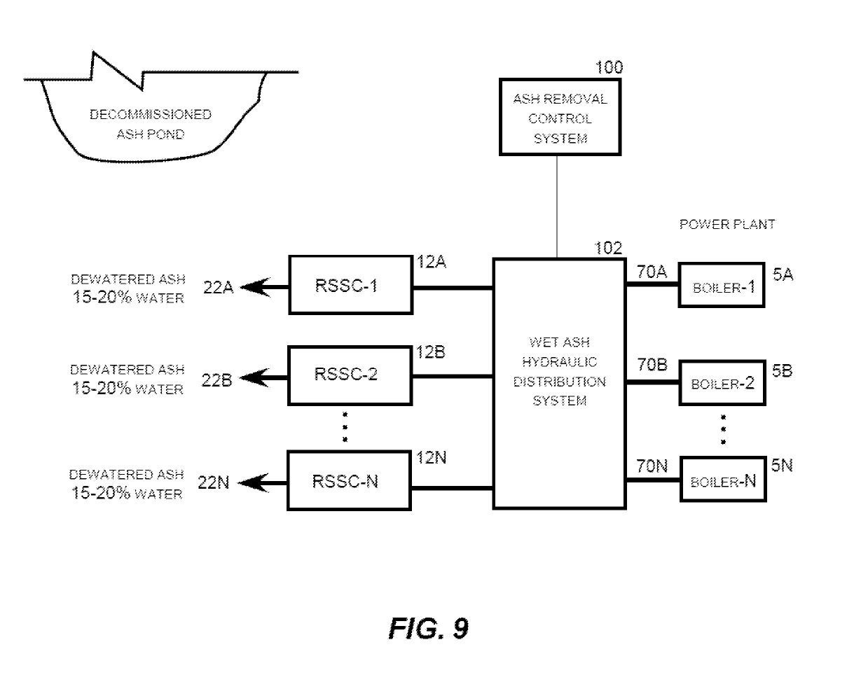

FIG. 9 is a schematic diagram of a Remote SSC bottom ash disposal system with a wet ash hydraulic distribution system. FIG. 9 represent a generalized case in which any number of Remote SSCs 12A-N handle the bottom ash slurry discharges from any number of boilers 5A-N boilers. An ash removal control system 100 controls the wet ash hydraulic distribution system 102 to direct the slurry discharge from any desired boiler to any desired Remote SSC. The wet ash hydraulic distribution system 102 typically includes pumps and valves for remotely controlling the delivery of bottom ash discharges to desired Remote SSCs as needed, which can be part of a comprehensive intelligent boiler cleaning system.

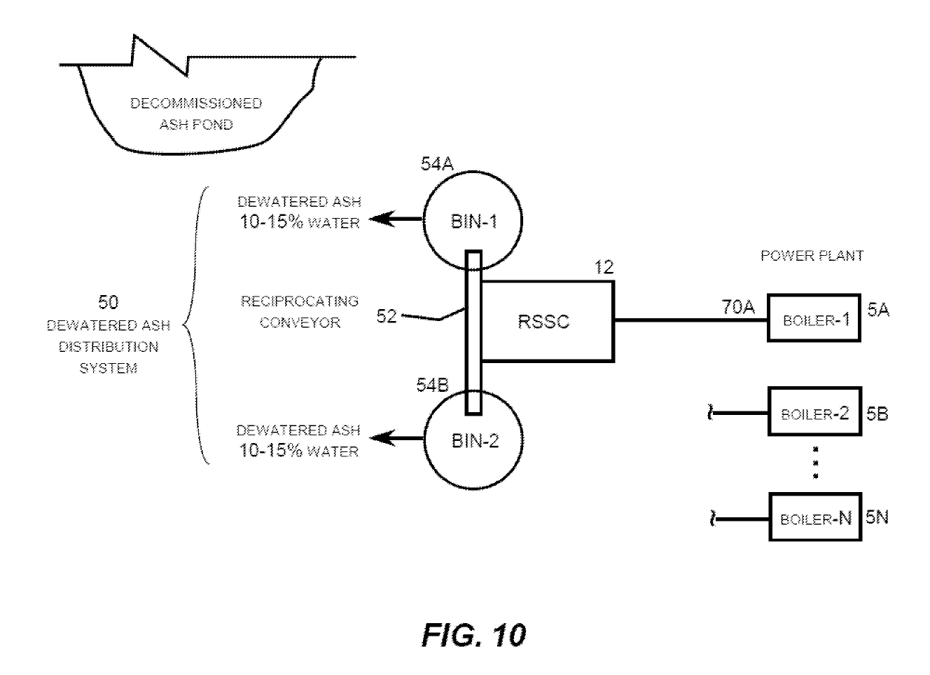

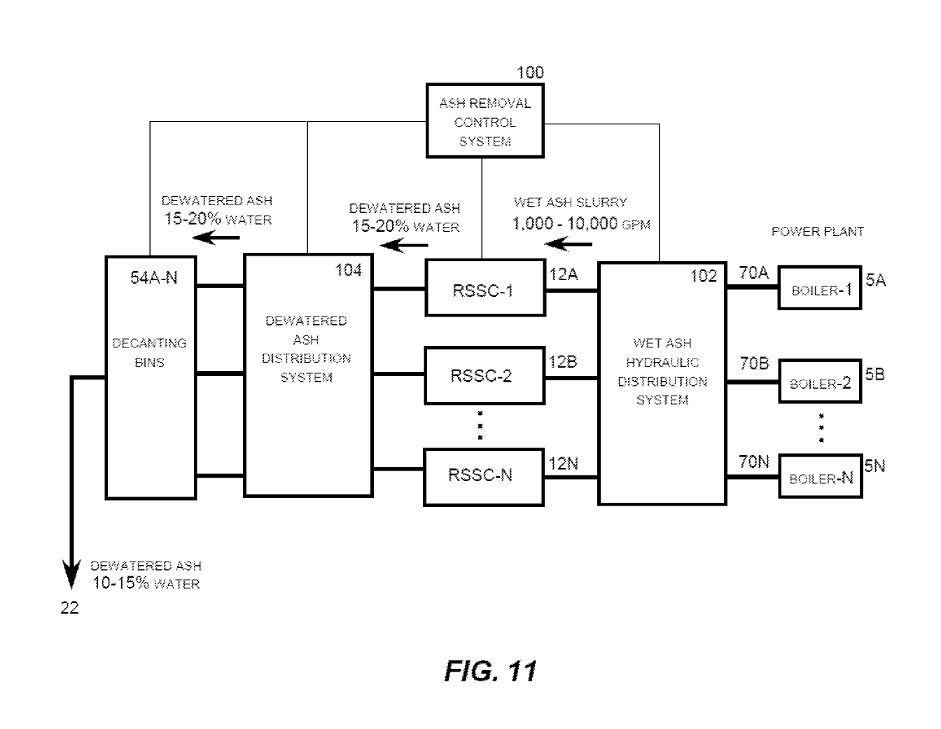

FIG. 10 is a schematic diagram of a Remote SSC bottom ash disposal system including the dewatered ash distribution system 50 shown in FIG. 2, which includes a pair of mini-dewatering bins 54A-B and a reciprocating conveyor 52 serving a single Remote SSC 12. This is one example of a dewatered ash distribution system that is generalized on FIG. 11. In this example, the bottom ash dewatering system includes a generalized dewatered ash distribution system 104 handling the dewatered ash from any number of Remote SSCs 12A-N under the control of the ash removal control system 100. The ash removal control system 100 remotely controls the wet ash hydraulic distribution system 102 as well as the dewatered ash distribution system 104. The dewatered ash distribution system 104 typically includes chutes, conveyors, bins and storage piles for handling the dewatered ash as desired.

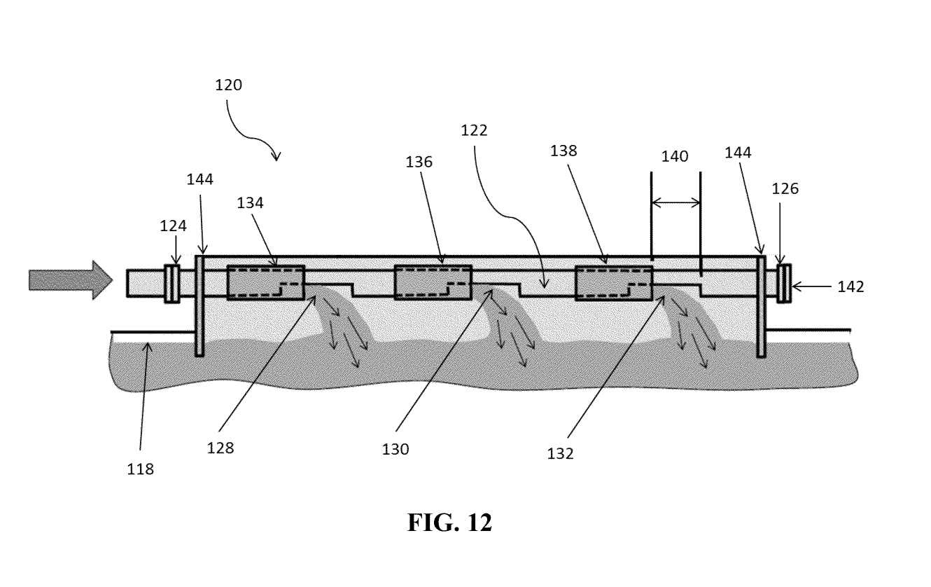

In order to reduce incoming water velocity and to better distribute ash in the horizontal section of the submerged scraper conveyor, a variable flow device for delivering the ash slurry is provided. A variable flow device according to one aspect of the invention is depicted in FIG. 12. As shown in FIG. 12, the variable flow device 120 comprises a pipe section 122 having a wall extending along an axis, the pipe section having a first end 124 and a second end 126. As shown in FIG. 12, the variable flow device comprises a plurality of openings 128, 130, 132 in a first side of the wall of the pipe section. Although three openings are shown in FIG. 12, the variable flow device can have two or more openings. As also shown in FIG. 12, the device also comprises adjustable sleeves 134, 136, 138 around the pipe section 122 adjacent to or covering at least part of each of the openings 128, 130, 132. Each of the adjustable sleeves is adapted to be displaced axially with respect to the pipe section to allow the size of the openings 140 to be adjusted. The second end 126 of the pipe section can be covered. As shown in FIG. 12, a cap 142 covers the second end 126 of the pipe section. The upper level of the water filling the horizontal section of the submerged scraper conveyor or water line 118 is also shown in FIG. 12.

According to some embodiments, the pipe section and each of the adjustable sleeves can have a circular cross-section. According to some embodiments, the openings in the pipe section of the variable flow device are rectangular in shape.

The variable flow device can be used in a bottom ash dewatering system for a boiler comprising a submerged scraper conveyor located remotely from the boiler. The submerged scraper conveyor includes a horizontal section, a dewatering incline section, and a conveyor running through the horizontal and dewatering incline sections. The horizontal section of the submerged scraper conveyor has a water line defining a level above which water in the horizontal section will overflow into an overflow trough system. The conveyor runs through the horizontal section at a level below the water line. The system also includes an ash hopper located under the boiler. A slurry discharge pipe is adapted to deliver ash slurry from the ash hopper into the horizontal section of the submerged scraper conveyor. The variable flow device can be connected to the end of the slurry discharge pipe and positioned above the horizontal section of a submerged scraper conveyor such that slurry pumped through the slurry discharge pipe flows through the openings and into the horizontal section of the submerged scraper conveyor.

The bottom ash dewatering system can further include a weir system located in a water flow direction between the horizontal section of the submerged scraper conveyor and the overflow trough system. The weir system can include one or more weir sections. Each of the weir sections can comprise a weir as depicted in FIGS. 5A-5D. According to some embodiments, a weir as depicted in FIG. 5C comprising a plurality of intersecting rods forming openings can be used. According to some embodiments, the openings can have a size of 0.060 mils (0.001524 mm) +/−10%. Water overflowing from the horizontal section into the trough system passes through the one or more weir sections.

According to some embodiments, the horizontal section of the submerged scraper conveyor comprises a storage zone adjacent the dewatering incline section and a settling zone adjacent the storage zone. According to some embodiments, the slurry discharge pipe is adapted to deliver the wet ash slurry from the ash hopper into the storage zone of the horizontal section of the submerged scraper conveyor. According to some embodiments, the overflow trough system is located in the settling zone of the horizontal section of the submerged scraper conveyor.

The bottom ash dewatering system can further include an inlet/underflow baffle having one or more walls extending below the water line and defining an interior volume, wherein slurry pumped through the slurry discharge pipe flows through the first and second openings and into the interior volume of the inlet/underflow baffle. An inlet/underflow baffle 144 is also shown in FIG. 12. As shown in FIG. 12, the pipe section of the variable flow device can extend through an opening in the inlet/underflow baffle. Alternatively, the slurry discharge pipe can extend through an opening in the inlet/underflow baffle and the connection between the variable flow device and the end of the slurry discharge pipe can be inside the inlet/underflow baffle. According to some embodiments, the inlet/underflow baffle can have a closed top. According to some embodiments, the inlet/underflow baffle can be a rectangular box.

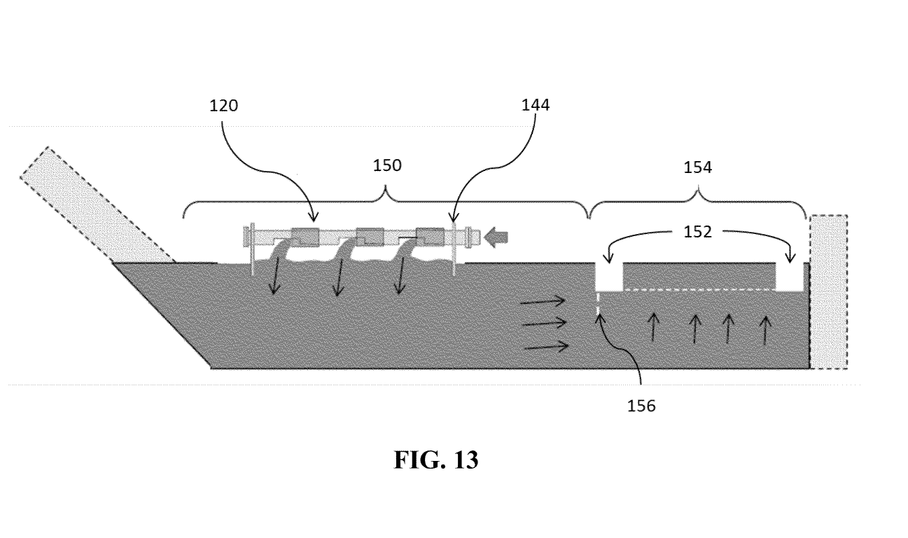

A submerged scraper conveyor including a variable flow device 120 positioned above the storage zone 150 of the horizontal section of the submerged scraper conveyor is shown in FIG. 13. As shown in FIG. 13, the variable flow device is positioned inside an inlet/underflow baffle 144. As also shown in FIG. 13, the submerged scraper conveyor includes a trough system 152 in the settling zone 154 of the horizontal section of the submerged scraper conveyor. The trough system includes trough sections shown in cross-section in FIG. 13 which extend across the horizontal section of the submerged scraper conveyor. The trough section closest to the incline section as shown in FIG. 13 includes an underflow baffle 156 extending downward from the bottom of the trough section on the side of the trough section facing the incline section.

As also shown in FIG. 13, the variable flow device is positioned parallel to the water line and is oriented such that the slurry flowing through the openings in the variable flow device is directed toward the incline section of the submerged scraper conveyor. While a parallel positioning is shown, the variable flow device can be positioned at a slight angle (e.g., +/−10 degrees) to the waterline. Similarly, while an orientation parallel to the long sides of the horizontal section is shown, the variable flow device can be oriented at a slight angle (e.g., +/−10 degrees) to the long sides of the horizontal section.

According to some embodiments, an overflow trough system for a submerged scraper conveyor is provided. The overflow trough system includes a first trough section adjacent a first side wall of the horizontal section, a second trough section adjacent a second side wall of the horizontal section opposite the first trough section and one or more trough connecting sections between the first trough section and the second trough section. At least one of the trough connecting sections can be spaced from a second end of the horizontal section of the submerged scraper conveyor opposite the incline section thereby defining a settling zone between the connecting trough section and the second end. The trough connecting section can have an underflow baffle extending downward from the bottom of the trough. The overflow trough system can include a weir system comprising a first weir section located in a water flow direction between the horizontal section of the submerged scraper conveyor and the first trough section and a second weir section located in a water flow direction between the horizontal section of the submerged scraper conveyor and the second trough section.

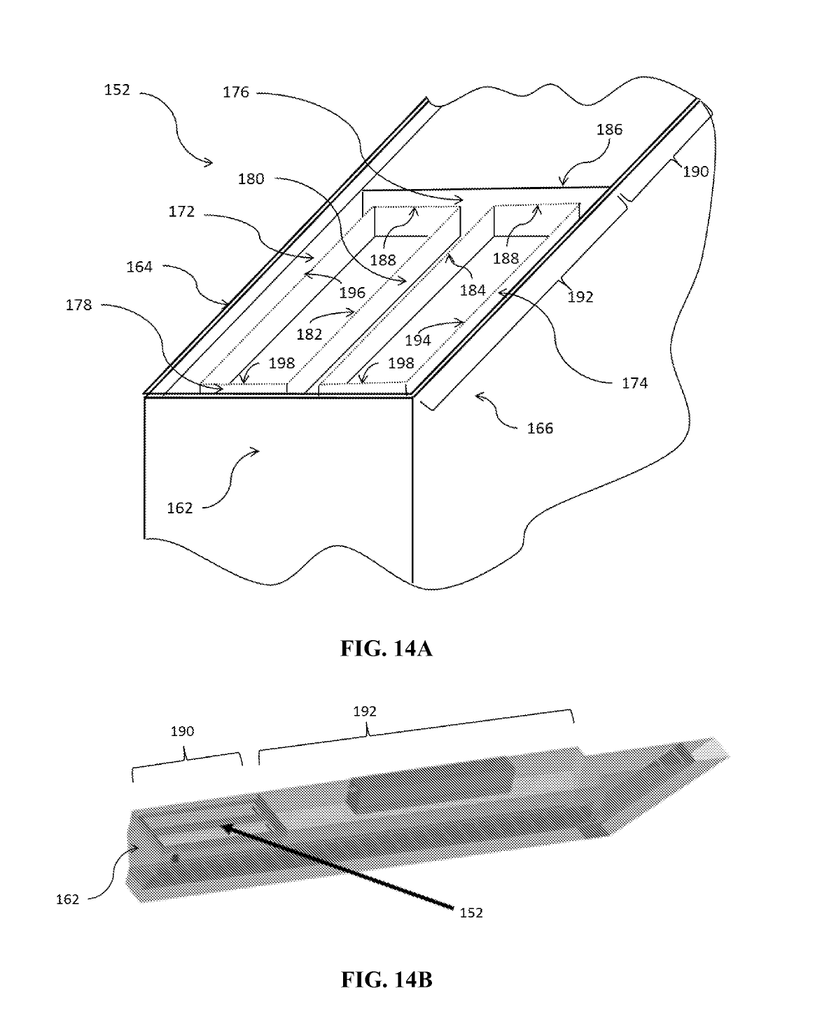

A trough system 152 for a submerged scraper conveyor is shown in FIG. 14A. As shown in FIG. 14A, the trough system includes a first trough section 172 adjacent a first wall 164 of the horizontal section, a second trough section 174 adjacent a second wall 166 of the horizontal section opposite the first trough section, a first trough connecting section 176 between the first trough section 172 and the second trough section 174 and a second trough connecting section 178 between the first trough section 172 and the second trough section 174. As shown in FIG. 14A, the first trough connecting section 176 connects a first end of the first trough section 172 to a first end of the second trough section 174 and the second trough connecting section 178 connects a second end of the first trough section 172 to a second end of the second trough section 174.

As shown in FIG. 14B, the trough system 152 can be positioned in the submerged scraper conveyor such that the second trough connecting section 178 is adjacent a second end 162 of the horizontal section of the submerged scraper conveyor opposite the incline section. As shown in FIGS. 14A and 14B, the first trough connecting section 186 bisects the horizontal section of the submerged scraper conveyor at the water line thereby defining a storage zone 190 adjacent the incline section and a settling zone 192 adjacent the end 162 of the horizontal section opposite the incline section.

As shown in FIG. 14A, a first side 186 of the first trough connecting section 176 adjacent the storage zone can extend above the water line such that water cannot overflow into the first trough connecting section from the storage zone. Slurry from the storage zone flows under the first trough connecting section 176 to enter the overflow trough system in the settling zone. In this manner, ash on or near the water surface cannot flow directly into the overflow trough system. Trough connecting section 176 can be provided with an underflow baffle 156 as shown in FIG. 13 to further promote settling of the ash in the slurry.

As shown in FIGS. 14A and 14B, the overflow trough system can also include a central trough section 180 spaced from the first and second trough sections 172, 174 and connecting the first trough connecting section 176 to the second trough connecting section 178. As shown in FIG. 14A, the central trough section has first and second opposed sides and water can overflow into the central trough section over each of the first and second sides of the central trough section.

The overflow trough system can also include a weir system. The weir system can comprise one or more weir sections. Weir sections are depicted as dotted lines in FIG. 14A. As shown in FIG. 14A, the weir system comprises: a first weir section 196 located adjacent the first trough section 172, a second weir section 194 located adjacent the second trough section 174, a pair of first weir connecting sections 188 located adjacent the first trough connecting section 176 and a pair of second weir connecting sections 198 located adjacent the second trough connecting section 174. As shown in FIG. 14A, the weir system also includes a first central weir section 182 and a second central weir section 184 extending along the opposed sides of the central trough section. The design depicted in FIG. 14 therefore comprises eight separate weir sections and allows a relatively large amount of linear feet of weir to be incorporated into a relatively small area of the horizontal section of the submerged scraper conveyor.

The overflow trough system can be used in combination with a slurry discharge pipe comprising a variable flow discharge device and an inlet/underflow baffle as described above.

A method of conveying bottom ash generated from combustion in a furnace is also provided. According to some embodiments, the method comprises combining the ash with water to form a slurry and pumping the slurry to a submerged scraper conveyor located remotely from the furnace. The submerged scraper conveyor includes a horizontal section, a dewatering incline section, a conveyor running through the horizontal and dewatering incline sections, an overflow trough system and a weir system located between the horizontal section of the submerged scraper conveyor and the overflow trough system. The horizontal section contains water and has a water line defining a level above which water in the horizontal section will flow through the weir and into the overflow trough system. The conveyor runs through the horizontal section at a level below the water line. The slurry is pumped into the horizontal section of the submerged scraper conveyor. The slurry is then conveyed from the horizontal section up the incline section to dewater the slurry. According to some embodiments, the slurry is pumped from the furnace to the submerged scraper conveyor at a rate of 1,000 to 10,000 gallons per minute (227 to 2,271 m³/hour) and the submerged scraper conveyor comprises at least 1 linear foot of weir for each 30 gallons per minute of slurry flow rate. According to some embodiments, the ash at the top of the incline section has a water content of 20% or less by weight. According to some embodiments, the slurry is pumped from the furnace to the submerged scraper conveyor at a rate of at least 2,000 gallons per minute. According to some embodiments, the slurry is pumped from the furnace to the submerged scraper conveyor at a rate of at least 3,000 gallons per minute.

By using the variable flow device, the inlet velocity of the slurry can be reduced and the flow distribution of the slurry in the horizontal section of the submerged scraper conveyor can be controlled. By reducing the inlet flow velocity, the wear on the submerged scraper conveyor can also be reduced.

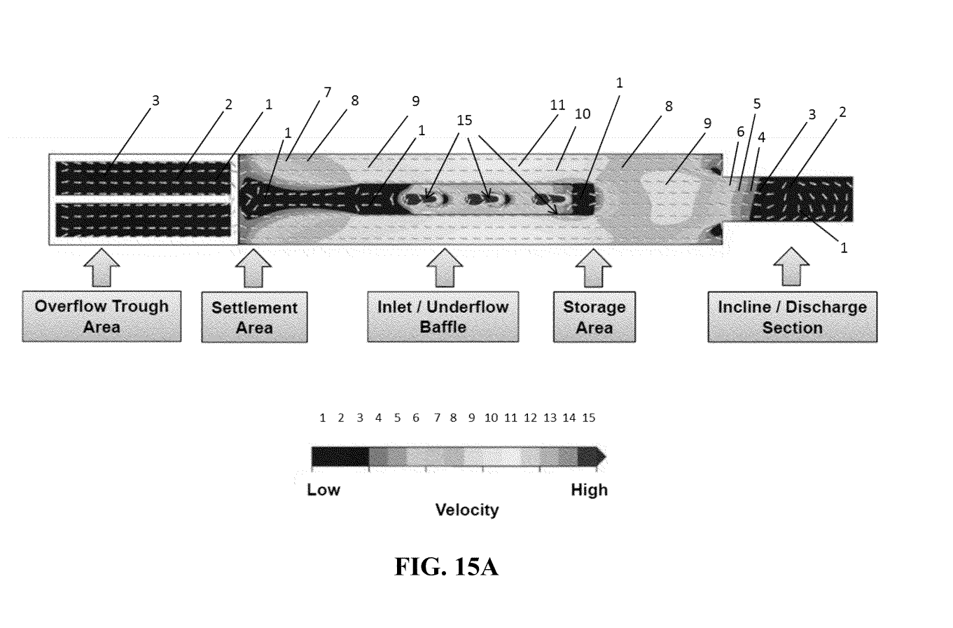

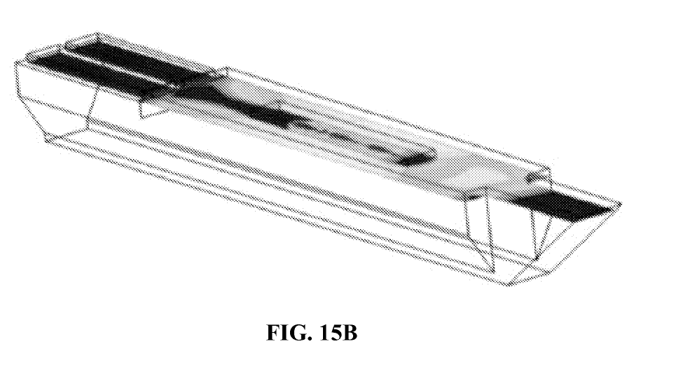

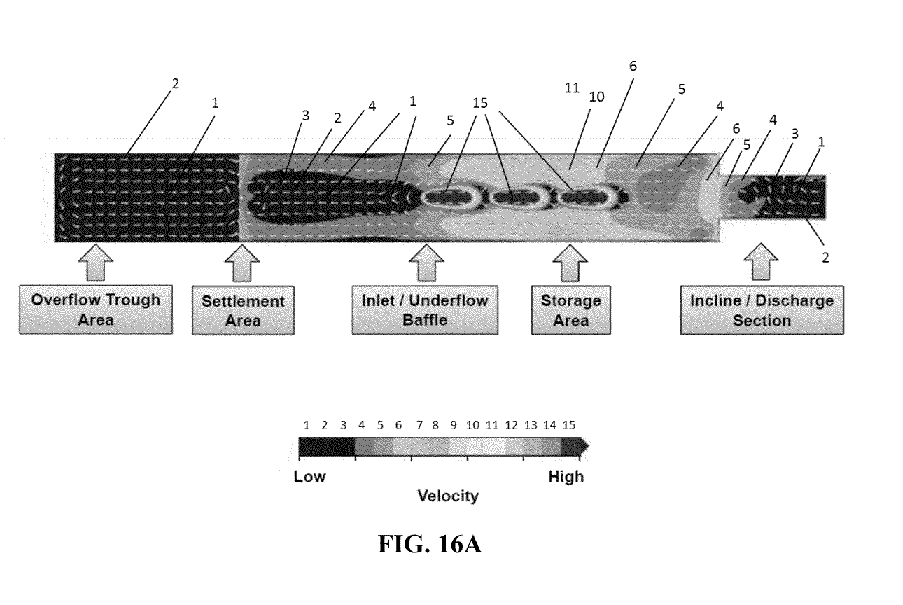

FIG. 15A is a simulation showing water flow direction and velocity in a lateral cross section of a submerged scraper conveyor at a position just below the waterline wherein slurry is delivered using a variable flow device. Relative water velocity is measured in a scale from 1 to 15 with 1 being the lowest and 15 being the highest velocity. As can be seen from FIG. 15A, water velocity is low in the overflow trough area and is highest in the inlet/underflow baffle area where the slurry is discharged into the submerged scraper conveyor. FIG. 15B shows the position of the lateral cross-section of FIG. 15A in relation to the submerged scraper conveyor.

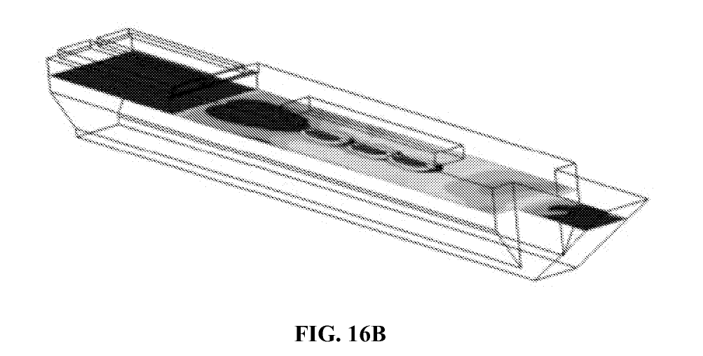

FIG. 16A shows the water flow direction and velocity in a lateral cross section of a submerged scraper conveyor at a position below the inlet/underflow baffle. As can be seen from FIG. 16A, water velocity is low in the overflow trough area and is highest in the inlet/underflow baffle area below where the slurry is discharged into the submerged scraper conveyor. FIG. 16B shows the position of the lateral cross-section of FIG. 16A in relation to the submerged scraper conveyor.

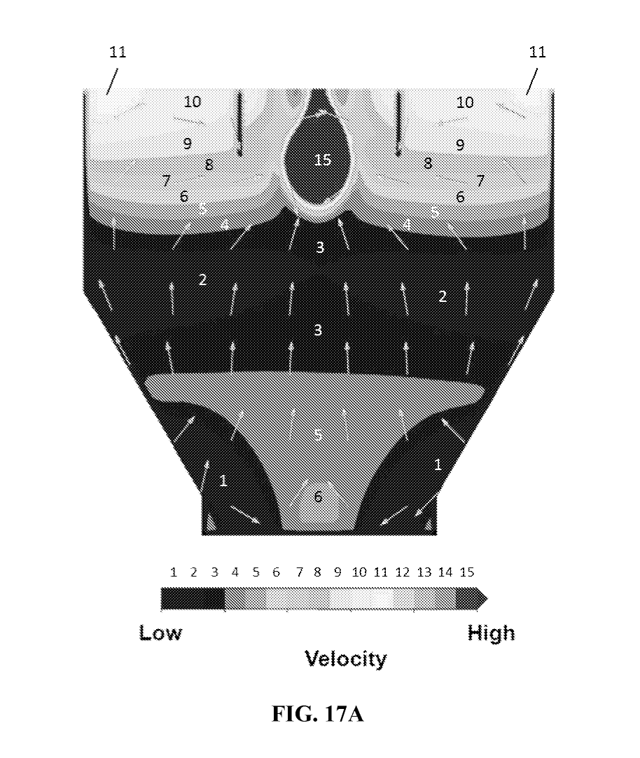

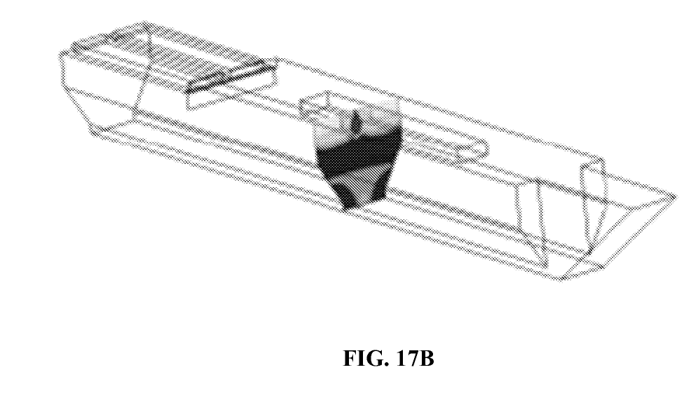

FIG. 17A shows the water flow direction and velocity in a transverse cross section of a submerged scraper conveyor at a position bisecting the inlet/underflow baffle. FIG. 17B shows the position of the transverse cross-section of FIG. 17A in relation to the submerged scraper conveyor.

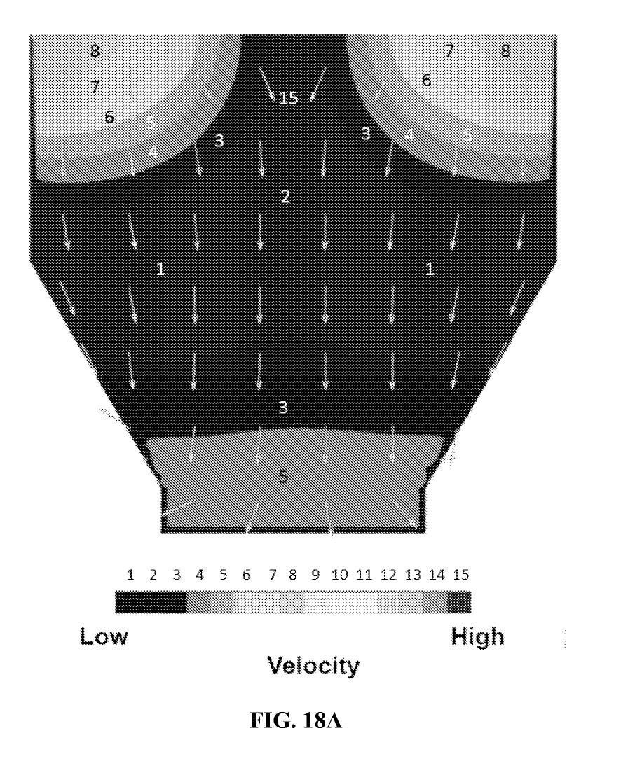

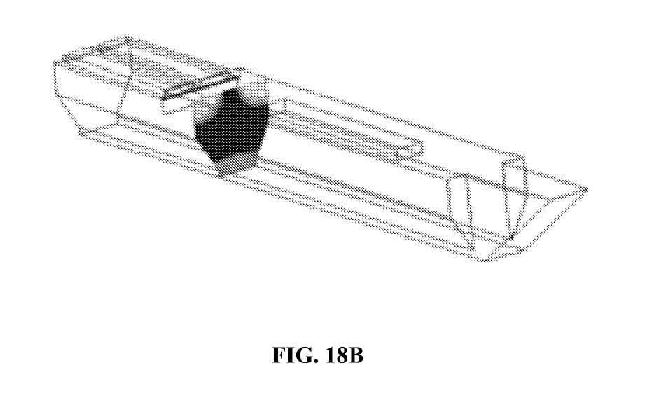

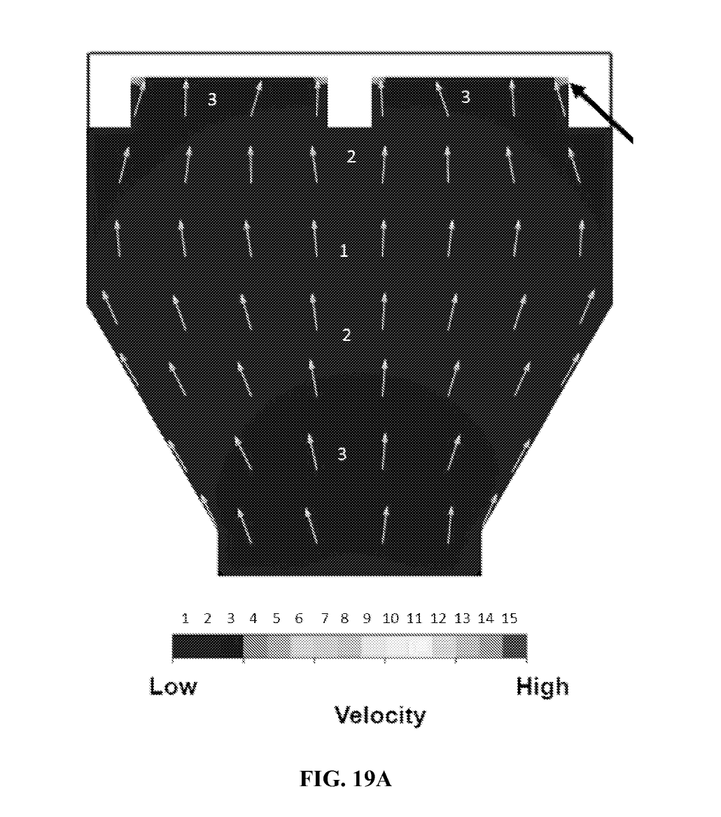

FIG. 18A shows the water flow direction and velocity in a transverse cross section of a submerged scraper conveyor at a position between the inlet/underflow baffle and the settling zone. FIG. 18B shows the position of the transverse cross-section of FIG. 18A in relation to the submerged scraper conveyor.

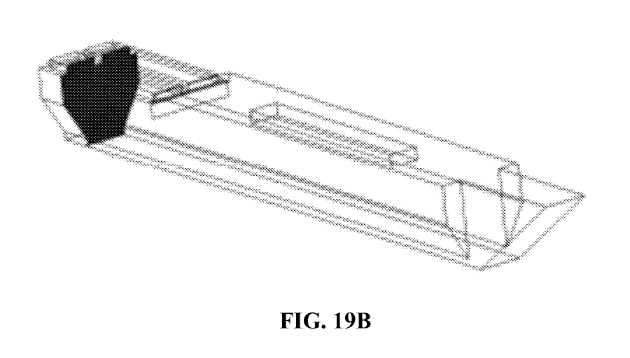

FIG. 19A shows the water flow direction and velocity in a transverse cross section of a submerged scraper conveyor at a position in the settling zone. FIG. 19B shows the position of the transverse cross-section of FIG. 19A in relation to the submerged scraper conveyor. As can be seen from FIG. 19A, overflow velocity (i.e., velocity of the water entering the overflow trough) is kept low due to the high ratio of the linear feet of weir to the slurry flow rate. By keeping the overflow velocity low, particulate carryover and discharge into the overflow trough system will be minimized providing for cleaner discharge water.

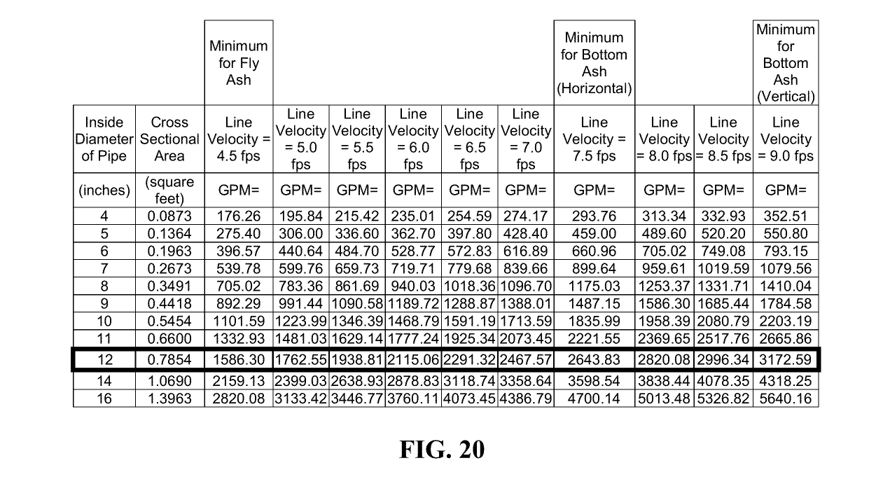

FIG. 20 is a chart showing slurry flow rate through a pipeline as a function of inside pipe diameter in inches (in) and line velocity in feet per second (fps). The minimum velocity to prevent the solids in the slurry from settling is also shown for fly ash and bottom ash transported in a horizontal and vertical pipeline. The minimum velocity is a function the type and size of the solid particles in the slurry. As can be seen from FIG. 20, for bottom ash in a 12 inch internal diameter pipeline, bottom ash can be conveyed at a minimum flow rate of 2643.83 gallons per minute (gpm) in a horizontal pipe and 3172.9 gallons per minute (gpm) in a vertical pipe. Using the relationship between linear feet of weir and slurry flow rate in gpm described above (i.e., 1 linear foot of weir for each 30 gallons per minute of slurry flow rate), a remote submerged scraper conveyor having at least 88.13 linear feet of weir at a slurry flow rate of 2643.83 gallons per minute (gpm) and 105.76 linear feet of weir at a slurry flow rate of 3172.9 gallons per minute (gpm) could be used to dewater bottom ash.

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A variable flow device comprising:
a pipe section comprising a wall extending along an axis, the pipe section having a first end and a second end;
a first opening in a first side of the wall of the pipe section;
a second opening in the first side of the wall of the pipe section displaced from the first opening along the axis of the pipe section;
a first adjustable sleeve around the pipe section adjacent to or covering at least part of the first opening, the first adjustable sleeve adapted to be displaced axially with respect to the pipe section to allow the amount of the first opening covered by the sleeve to be adjusted; and
a second adjustable sleeve around the pipe section adjacent to or covering at least part of the second opening, the second adjustable sleeve adapted to be displaced axially with respect to the pipe section to allow the amount of the second opening covered by the sleeve to be adjusted.

2. The variable flow device of claim 1, wherein the pipe section and each of the first and second sleeves has a circular cross-section.

3. The variable flow device of claim 1, wherein the first and second openings are rectangular in shape.

4. The variable flow device of claim 1, wherein the second end of the pipe section is closed.

5. A bottom ash dewatering system for a boiler comprising:
a submerged scraper conveyor located remotely from the boiler, the submerged scraper conveyor comprising a horizontal section, a dewatering incline section, and a conveyor running through the horizontal and dewatering incline sections;
an ash hopper located under the boiler; and
a slurry discharge pipe adapted to deliver a wet ash slurry from the ash hopper into the horizontal section of the submerged scraper conveyor, wherein the slurry discharge pipe comprises a variable flow device as set forth in claim 1 positioned above the horizontal section of the submerged scraper conveyor such that slurry pumped through the slurry discharge pipe flows through the first and second openings and into the horizontal section of the submerged scraper conveyor.

6. The bottom ash dewatering system of claim 5, further comprising:
an overflow trough system; and
optionally, a weir system located in a first water flow direction between the horizontal section of the submerged scraper conveyor and the overflow trough system;
wherein the horizontal section of the submerged scraper conveyor has a water line defining a level above which water in the horizontal section will overflow into the overflow trough; and
wherein the conveyor runs through the horizontal section at a level below the water line.

7. The bottom ash dewatering system of claim 6, wherein the horizontal section of the submerged scraper conveyor comprises a storage zone adjacent the dewatering incline section and a settling zone adjacent the storage zone;
wherein the slurry discharge pipe is adapted to deliver the wet ash slurry from the ash hopper into the storage zone of the horizontal section of the submerged scraper conveyor; and
wherein the overflow trough system is in the settling zone of the horizontal section of the submerged scraper conveyor.

8. The bottom ash dewatering system of claim 5, further comprising an inlet/underflow baffle having one or more walls extending below the water line and defining an interior volume, wherein slurry pumped through the slurry discharge pipe flows through the first and second openings and into the interior volume of the inlet/underflow baffle.

9. The bottom ash dewatering system of claim 8, wherein the slurry discharge pipe extends through an opening in the one or more walls of the inlet/underflow baffle.

10. The bottom ash dewatering system of claim 9, wherein the inlet/underflow baffle has a closed top.

11. The bottom ash dewatering system of claim 9, wherein the inlet/underflow baffle comprises a rectangular box.

12. A bottom ash dewatering system for a boiler comprising:
a submerged scraper conveyor located remotely from the boiler, the submerged scraper conveyor comprising a horizontal section comprising first and second side walls and first and second ends, a dewatering incline section adjacent a first end of the horizontal section, and a conveyor running through the horizontal and dewatering incline sections;
an ash hopper located under the boiler;
a slurry discharge pipe adapted to deliver a wet ash slurry from the ash hopper into the horizontal section of the submerged scraper conveyor; and
an overflow trough system comprising a first trough section adjacent the first wall of the horizontal section, a second trough section adjacent the second wall of the horizontal section opposite the first trough section and one or more trough connecting sections between the first trough section and the second trough section;
wherein the horizontal section of the submerged scraper conveyor has a water line defining a level above which water in the horizontal section will overflow into the overflow trough system; and
wherein the conveyor runs through the horizontal section at a level below the water line.

13. The bottom ash dewatering system of claim 12, further comprising:
a first weir section located in a first water flow direction between the horizontal section of the submerged scraper conveyor and the first trough section;
a second weir section located in a second water flow direction between the horizontal section of the submerged scraper conveyor and the second trough section; and/or
one or more weir connecting sections located in a water flow direction between the horizontal section of the submerged scraper conveyor and each of the one or more weir connecting sections.

14. The bottom ash dewatering system of claim 12, wherein the overflow trough system comprises:
a first trough connecting section connecting a first end of the first trough section to a first end of the second trough section; and
a second trough connecting section connecting a second end of the first trough section to a second end of the second trough section.

15. The bottom ash dewatering system of claim 14, wherein the second trough connecting section is adjacent the second end of the horizontal section and the first trough connecting section bisects the horizontal section at the water line defining a storage zone adjacent the first end of the horizontal section and a settling zone adjacent the second end of the horizontal section.

16. The bottom ash dewatering system of claim 15, wherein a first side of the first trough connecting section adjacent the storage zone extends above the water line such that water cannot overflow into the first trough connecting section from the storage zone.

17. The bottom ash dewatering system of claim 15, wherein the slurry discharge pipe is adapted to deliver the wet ash slurry from the ash hopper into the storage zone of the horizontal section of the submerged scraper conveyor.

18. The bottom ash dewatering system of claim 14, wherein the overflow trough comprises a central trough section spaced from the first and second trough sections and connecting the first trough connecting section to the second trough connecting section, wherein the central trough section has first and second opposed sides and wherein water can overflow into the central trough section over each of the first and second sides of the central trough section.

19. The bottom ash dewatering system of claim 18, further comprising:
a first central weir section extending along the first side of the central trough section such that water overflowing into the central trough section over the first side of the central trough section passes through the first central weir section; and
a second central weir section extending along the second side of the central trough section such that water overflowing into the central trough section over the second side of the central trough section passes through the second central weir section.

20. The bottom ash dewatering system of claim 12, wherein the slurry discharge pipe comprises a variable flow discharge pipe section comprising a wall extending along an axis, the pipe section having a first end and a second end;
a first opening in a first side of the wall of the pipe section;
a second opening in the first side of the wall of the pipe section displaced from the first opening along the axis of the pipe section;
a first adjustable sleeve around the pipe section adjacent to or covering at least part of the first opening, the first adjustable sleeve adapted to be displaced axially with respect to the pipe section to allow the amount of the first opening covered by the sleeve to be adjusted; and
a second adjustable sleeve around the pipe section adjacent to or covering at least part of the second opening, the second adjustable sleeve adapted to be displaced axially with respect to the pipe section to allow the amount of the second opening covered by the sleeve to be adjusted;
wherein the variable flow discharge pipe section is positioned above the horizontal section of the submerged scraper conveyor such that slurry pumped through the slurry discharge pipe flows through the first and second openings and into the horizontal section of the submerged scraper conveyor.

21. A method of conveying bottom ash generated from combustion in a furnace, the method comprising:
combining the ash with water to form a slurry;
pumping the slurry to a submerged scraper conveyor located remotely from the furnace, the submerged scraper conveyor comprising:
a horizontal section;
a dewatering incline section;
a conveyor running through the horizontal and dewatering incline sections;
an overflow trough system; and
a weir system located between the horizontal section of the submerged scraper conveyor and the overflow trough system;
wherein the horizontal section contains water and has a water line defining a level above which water in the horizontal section will flow through the weir system and into the overflow trough system, wherein the conveyor runs through the horizontal section at a level below the water line and wherein the slurry is pumped into the horizontal section of the submerged scraper conveyor; and
conveying the slurry from the horizontal section up the incline section to dewater the slurry;
wherein the slurry is pumped from the furnace to the submerged scraper conveyor at a rate of 1,000 to 10,000 gallons per minute (227 to 2,271 m³/hour); and
wherein the submerged scraper conveyor comprises at least 1 linear foot of weir for each 30 gallons per minute of slurry flow rate;

22. The method of claim 21, wherein the ash at the top of the incline section has a water content of 20% or less by weight.

23. The method of claim 21, wherein the slurry is pumped from the furnace to the submerged scraper conveyor at a rate of at least 2,000 gallons per minute.

24. The method of claim 21, wherein the slurry is pumped from the furnace to the submerged scraper conveyor at a rate of at least 3,000 gallons per minute.
